(19) United States
(12) Patent Application Publication
(10) Pub. No.: US 2011/0282781 A1
(43) Pub. Date: Nov. 17, 2011

(54) System and Method for Average Daily Balance Optimization for Accelerated Loan Payoff

(76) Inventor: Dennis Williams, JR., Bellingham, WA (US)

(21) Appl. No.: 13/105,156

(22) Filed: May 11, 2011

Related U.S. Application Data
(60) Provisional application No. 61/333,557, filed on May 11, 2010.

(51) Int. Cl. G06Q 40/00

(52) U.S. Cl. 705/39

(57) ABSTRACT

A system and method for average daily balance optimization forecast for accelerated loan payoff. A computing apparatus configured using computer readable program code enables optimization of an average daily balance using user-specified configuration of dates of income deposits and expense item withdrawals. Based on user-specified line of credit parameters and loan details, the configured computing apparatus can generate a recurring draw threshold and recurring draw amount that can be used by an individual in leveraging a line of credit for accelerated loan payoff.

This application claims priority to provisional application No. 61/333,557, filed May 11, 2010, which is incorporated by reference herein, in its entirety, for all purposes.

### TECHNICAL FIELD

The present invention relates generally to loan management tools. More particularly, the present invention relates to a system and method for average daily balance optimization forecast for accelerated loan payoff.

### BACKGROUND

Loans and other credit facilities are used extensively in today's society. Unfortunately, such pervasive use has not translated to effective personal management of those credit facilities. It is rare for individuals to have an understanding of how best to utilize their monetary assets. The consequence of such a lack of understanding is a long-standing and continuing inability for individuals to have their money effectively work for them.

Education in the area of personal finance is sorely needed. More importantly, what is needed is a tool that enables individuals to organize their personal finances and understand how small changes in their management of their personal finances can produce significant long-term results.

### SUMMARY

A system and method for average daily balance optimization forecast for accelerated loan payoff, substantially as shown in and/or described in connection with at least one of the figures, as set forth more completely in the claims.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIGS. 1A-1D illustrate examples of an impact of optimization of an average daily balance.

FIG. 2 illustrates a summary of an impact of adjustments in cash flow on an average daily balance.

FIGS. 3A and 3B illustrate an example of conventional payment of a line of credit.

FIGS. 4A and 4B illustrate an example of applying optimization of an average daily balance to a line of credit.

FIGS. 5A and 5B illustrate a comparison of approaches in repaying a line of credit.

FIG. 6 illustrates an impact of higher interest rates.

FIG. 7 illustrates a flowchart of a process of the present invention.

FIG. 8 illustrates an example graphical user interface for the entry of income-related information.

FIG. 9 illustrates an example graphical user interface for the entry of expense-related information.

FIG. 10 illustrates an example graphical user interface that enables optimization of an average daily balance.

FIG. 11 illustrates an example report generated for an accelerated loan payoff plan.

FIG. 12 illustrates an example report of an impact of executing an accelerated loan payoff plan.

### DETAILED DESCRIPTION

Various embodiments of the invention are discussed in detail below. While specific implementations are discussed, it should be understood that this is done for illustration purposes only. A person with ordinary skill in the relevant art will recognize that other components and configurations can be used without parting from the spirit and scope of the invention.

Interest rates that banks are paying for deposits is extremely low. Interest rates less than 1% are commonplace. Due to the volatility of the stock market and recent instances of financial fraud, more people are holding on to their cash and subsequently earning a very low return on their money.

In accordance with the present invention, it is recognized that a line of credit provides an excellent mechanism to shift and pay down debt at a significantly cheaper cost. As explained in detail below, the more optimal the average daily balance and the greater the positive cash flow, the greater the savings.

In general, a line of credit is an open loan that a financial institution allows an individual to use at his convenience. For example, the financial institution may provide a line of credit up to $25,000, where the individual is charged only when a withdrawal is made from the line of credit. While the interest rate may be variable, the interest charged is based upon the average daily balance during the billing cycle. Consequently, optimizing the average daily balance on a line of credit (i.e., keeping the average daily balance as low as possible) means minimizing the amount of interest charged.

To illustrate the value of optimizing the average daily balance, consider a scenario with the following regular transactions on an account:

Deposits
1. On the first of every month: $4,200.00

Payments
1. On the second, a car loan payment: $513.00
2. On the second, a Mortgage payment: $1,413.12
3. On the second, church offering: $487.00
4. On the second, household expenses: $500.00
4. On the second, home maintenance: $587.00

Remaining Balance (Positive Cash Flow): $518.00

Calculating the average daily balance for this scenario can be based on a simple process. First, identify the ending balance for each day of the month. Second, add each day together. Third, divide the total by the total number of days in the billing cycle for the month. In this example it is assumed that the month has thirty days, resulting in an average daily balance of $641.

It should be noted that if the financial institution uses the daily balance for it's calculation, there's one small difference. Each day, the interest rate divided by twelve is multiplied times the ending balance for the day. At the end of the month, each day's interest is added. This number would represent how much the individual pays or how much the individual is paid.

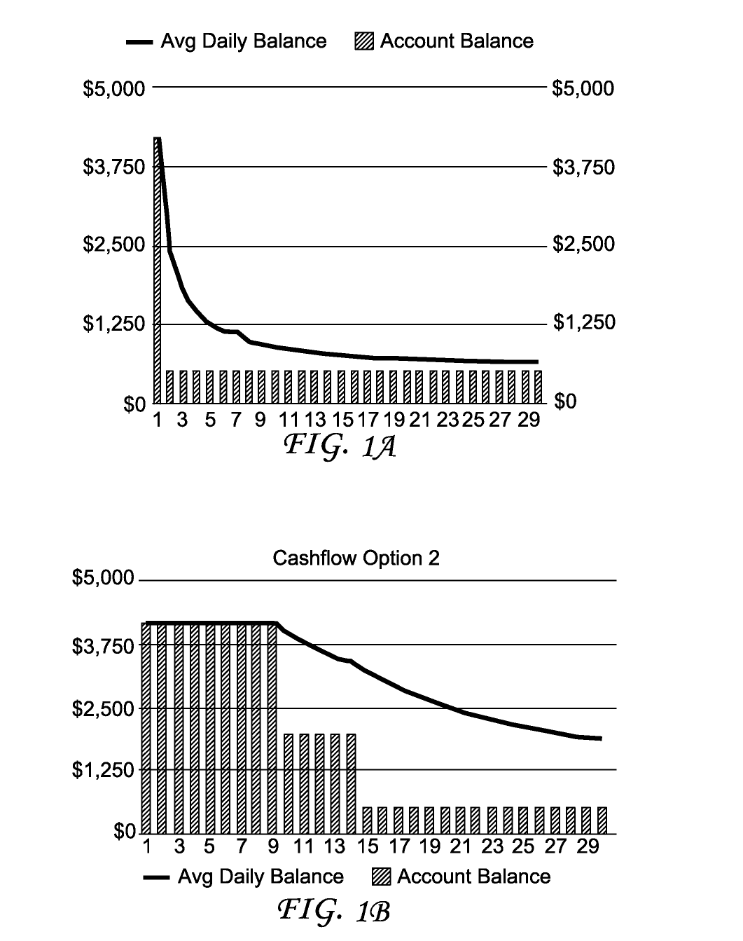

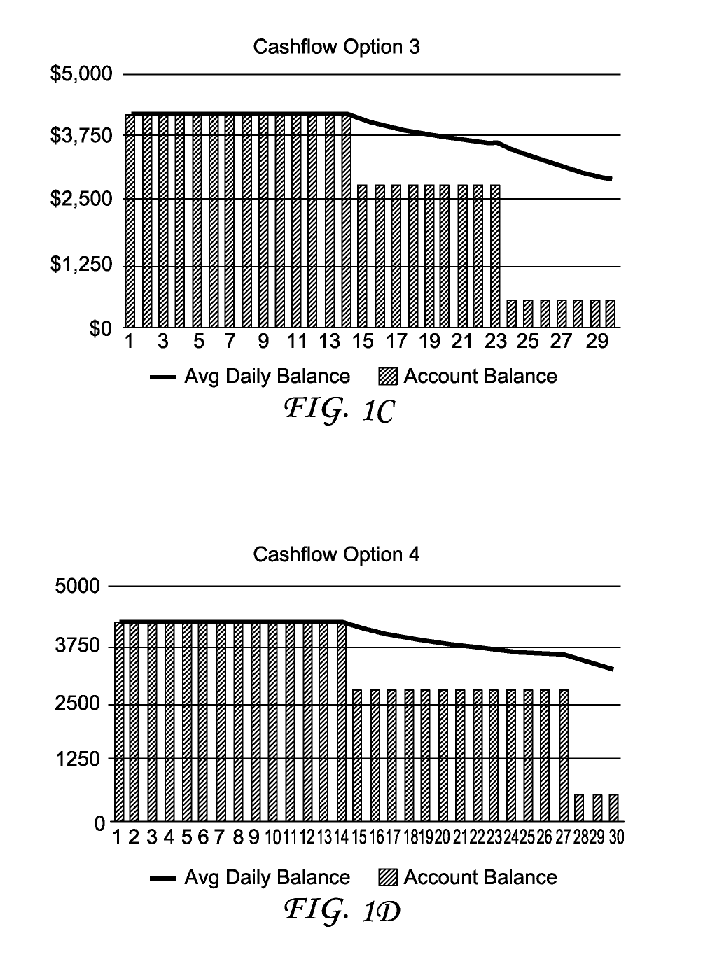

FIG. 1A illustrates the average daily balance for the above example and shows the immediate effects that deposits and withdrawals have on the average daily balance. As illustrated, the account balance stays at $518 from the 3^{rd} through the 30^{th} of the month. Hence, the average daily balance drops continually from the time the expenses hit the account. As the interest payment is based on your average daily balance, the natural question is how can the average balance be adjusted to lower the interest payment. The simplest way to do this is to make deposits earlier in the month and pay bills later in the month. A few scenarios showing the potential impact of those types of adjustments follows below.

First, consider a change where payment of each of the expenses is shifted from the 2^{nd} of the month to the 10^{th} of the month. As illustrated in FIG. 1B, the average daily balance is increased to $1,623, which represents a 153% increase as compared to the first cash flow option.

As is well known, there exists significant flexibility for individuals to modify the dates that payments are made. First, mortgage companies routinely provide a 15-day grace period before any late fees apply, thereby enabling use of an automatic bill paying program to have the mortgage paid on the 15^{th} of each month. Second, most financial institutions provide automatic on-line bill payment at no cost, thereby enabling scheduling of bill payments on specific dates in the required due-date timeframe. Third, credit cards can be used for regular routine purchases. The due date for the credit card can be set on a particular due date later in the month. Fourth, payment dates for loans can usually be moved at no cost. In general, the key is knowing the billing cycle dates and scheduling payments accordingly to the end of the billing cycle.

With this in mind, consider another change where the mortgage payment is shifted to the 15^{th} and the remaining expenses are shifted from the 24^{th}. As illustrated in FIG. 1C, the average daily balance is increased to $2,908, which represents a 354% increase as compared to the first cash flow option.

Finally, consider yet another change where the expenses on the 24^{th} are shifted to the 28^{th}. As illustrated in FIG. 1D, the average daily balance is increased to $3,206, which represents a 400% increase as compared to the first cash flow option.

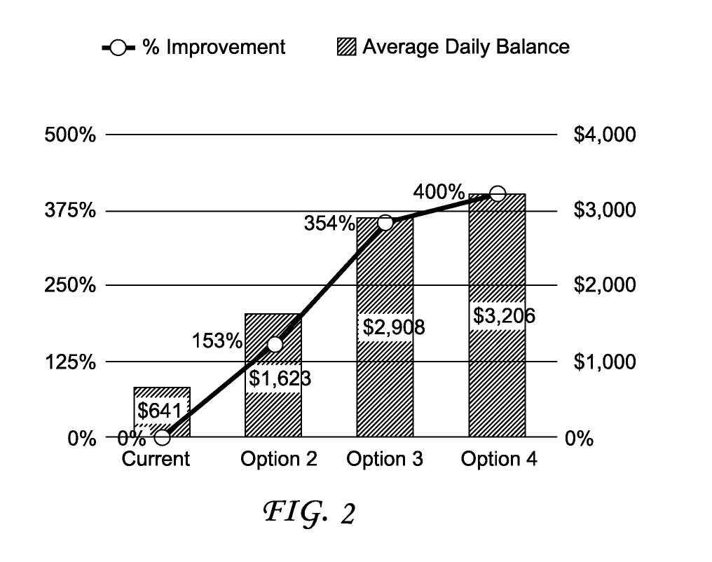

As these examples illustrate, without reducing spending or increasing income, the average daily balance for the individual can be increased by up to 400 percent. This means that the individual can dramatically increase the interest earned or dramatically reduce the interest paid by adjusting the cash flow on an account. The graph of FIG. 2 summarizes the results.

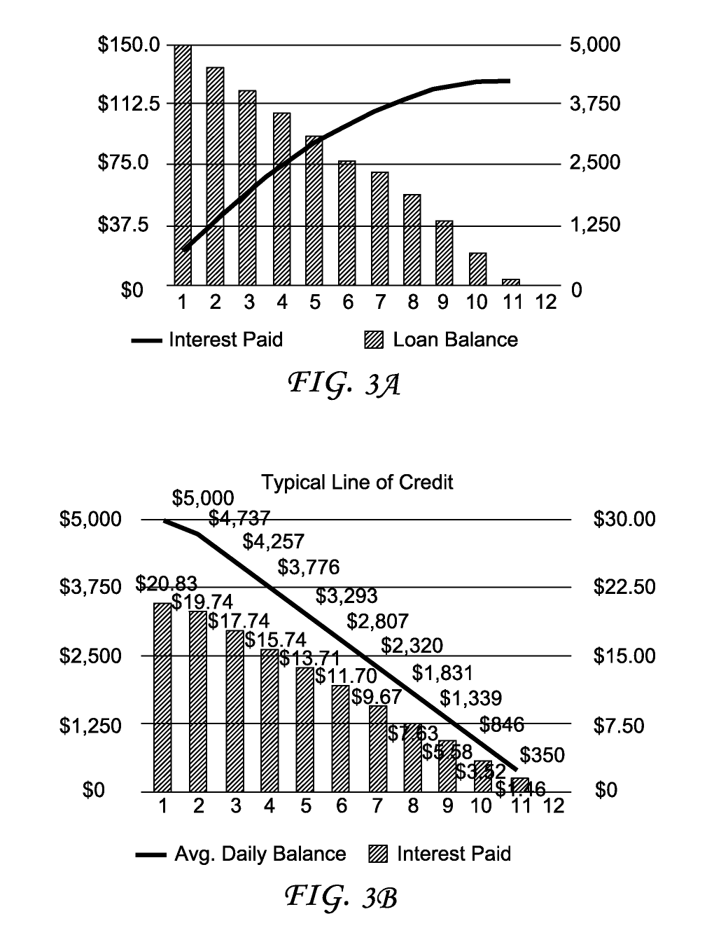

To illustrate the value of optimizing the average daily balance, reference is now made to a typical example of the usage of a line of credit such as a Home Equity Lines Of Credit (HELOC). In this example, assume that a line of credit has an interest rate of 5%, and $5,000 is drawn from the line of credit on the first of the month. A typical way of repaying a line of credit is to wait until a bill is received at the end of the billing cycle, and then to send a payment for the accrued interest plus an additional principal payment. In this example, a $500 principal payment is made each month. The graph of FIGS. 3A and 3B visualize the loan balance and the interest payments over the next 12 months. In the 12 months it takes to repay the bank, the total interest paid is $127.

In the present invention, optimization of the average daily balance can greatly affect this scenario. Here, it is recognized that money used to pay bills is kept in a checking account earning little interest. In a new approach, income is deposited to the line of credit and monthly bills are paid based on the optimized average daily balance illustrated in FIG. 1D.

When this optimized average daily balance is applied to the line of credit, the monthly income deposit immediately reduces the average daily balance, thereby lowering the interest owed, and the positive cash flow of $518 accelerates the date the loan is paid is in full. As would be appreciated, the individual has continued access to their money, which in turn provides the flexibility to put their money to work to reduce debt.

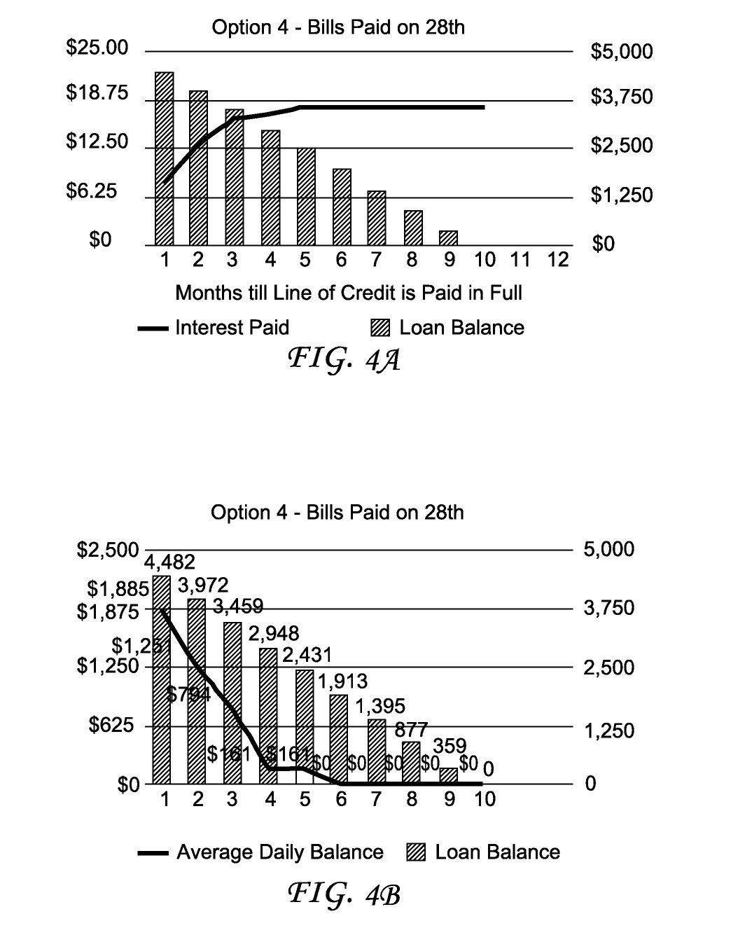

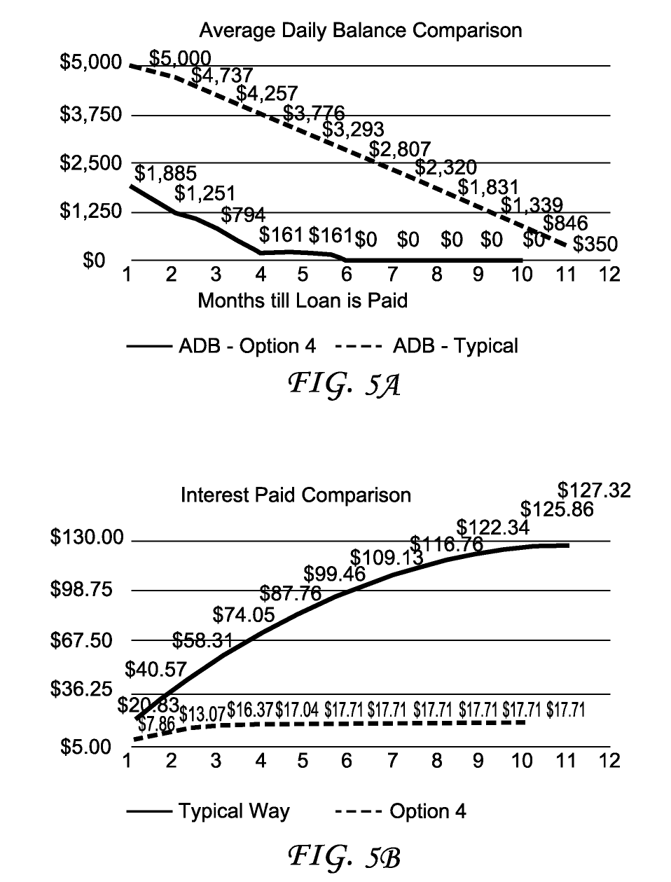

FIGS. 4A and 4B illustrate the impact of applying optimization of an average daily balance to the line of credit. As illustrated, the interest paid is just $17. This is in sharp contrast to the $127 in interest paid using a conventional repayment approach. FIGS. 5A and 5B illustrate a comparison between the two approaches in comparing the average daily balance and the interest paid, respectively.

The key to making such a dramatic difference is optimizing the average daily balance and using the line of credit to put an individual's hard earned money to work. As illustrated, seemingly insignificant changes in the timing that bills are paid can make a big difference.

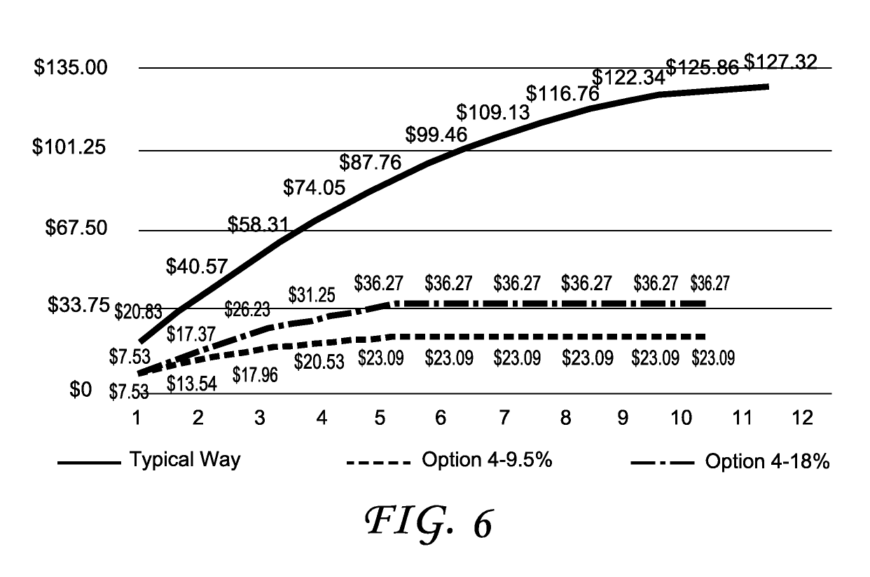

Here, it should be noted that the savings will remain significant even if the interest rate on the line of credit increases. FIG. 6 illustrates two scenarios where the interest rate increased from 5 to 9.5% over three months, and where the interest rate increased from 5 to 18 percent over three months. As illustrated the impact of the higher interest rates is relatively low.

Because the average daily balance is already so low, when the rate increases to 9.5% the total interest paid increases from $17 to $23, and when the rate increases to 18% the total interest paid increases from $17 to $36. These amounts of interest paid are still far below the $127 that would be paid using the typical approach of repaying a line of credit. In that typical approach, if the rate were to increase to 9.5%, $198 in total interest would be paid, while if the rate were to rise to 18%, the total interest paid would increase to a total of $242.

As this example illustrates, optimization of an average daily balance on a line of credit can transform the line of credit into a cheap source of credit. In the present invention, this cheap source of credit can be used advantageously in the acceleration of a payoff of a closed loan. In general, any loan that is not a line of credit, can be called a closed loan. A characteristic of a closed loan is that when a payment is sent in, there's no getting the money back. Examples of a closed loan include an auto loan, a student loan, a mortgage, or the like.

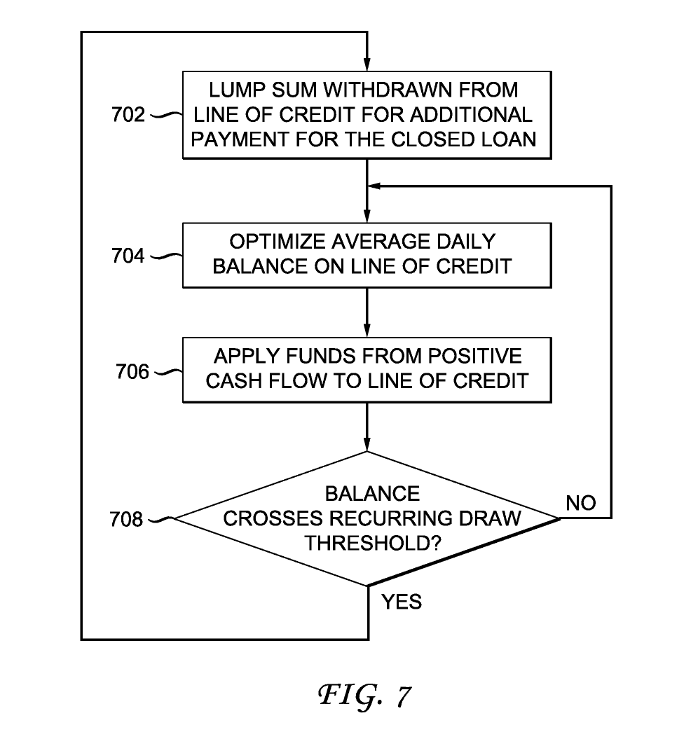

In the present invention, an application of the cheap source of credit created by optimization of an average daily balance on a line of credit is to shift small “chunks” from the closed line to the line of credit. This shifting is performed by taking a withdrawal from the line of credit and using those dollars as an additional payment to the closed loan. FIG. 7 illustrates a high-level flowchart of such a process.

As illustrated, the process begins at step 702 where a lump sum is withdrawn from the line of credit to be used as an additional payment on the closed loan. For example, a lump sum of $5,000 can be withdrawn and used as an additional payment on a mortgage. At step 704, the average daily balance on the line of credit is optimized. As has been described above, optimization of the average daily balance can be based on the shifting of expenses to the end of their individual billing cycles, which ideally have been shifted towards the end of the month. In various embodiments, the withdrawal of funds form the line of credit for expenses can be done manually or programmed for automatic execution. As would be appreciated, the principles of the present invention are not dependent on the specific implementation.

Next, at step 706, funds from the positive monthly cash flow are applied to the line of credit. The specific percentage of funds (e.g., 100, 80, 60, 40, etc.) from the positive monthly cash flow can vary. What is significant here is that the existence of positive cash flow enables the balance on the line of credit to be reduced on a continual monthly basis.

At step 708, it is then determined whether the balance on the line of credit has crossed a recurring draw threshold. Identification and establishment of this recurring draw threshold is described in greater detail below. In general, the function of the recurring draw threshold is to trigger recurring draws on the line of credit when the balance has been reduced to a target level through the continuing positive cash flow.

If it is determined at step 708, that the line of credit balance has not crossed the recurring draw threshold, then the process loops back to step 704 where optimization of the average daily balance on the line of credit continues. If, on the other hand, it is determined at step 708 that the line of credit balance has crossed the recurring draw threshold, then the process loops back to step 702 where an additional lump sump is withdrawn from the line of credit to be used as an additional payment on the closed loan. Identification and establishment of this recurring draw amount is described in greater detail below. For example, a recurring draw threshold of $2,500 can be established such that when the balance on the line of credit crosses the $2,500 recurring draw threshold, a recurring draw amount of $5,500 is withdrawn from the line of credit to be used as an additional payment on a mortgage.

In general, the recurring draw at those points in time when the balance on the line of credit crosses the recurring draw threshold represents a systematic process by which the cheap source of credit represented by the line of credit is leveraged. The identification of the recurring draw threshold and the recurring draw amount can be dependent on various factors.

For example, the recurring draw threshold and the recurring draw amount can be dependent on the interest rate of the line of credit. As an illustration, at 5%, the recurring draw amount of $4,000 can be withdrawn when the balance drops below the recurring draw threshold of $3,000, while at 12.5%, the recurring draw amount of $2,275 can be withdrawn when the balance drops below the recurring draw threshold of $1,850.

In one embodiment, the recurring draw threshold can be established based on a standard methodology using a single line of credit interest rate threshold. For example, if the interest rate on the line of credit is less than 5.749 percent, then the recurring draw threshold is equal to the monthly income deposited, while if the interest rate on the line of credit is greater than 5.749 percent, then the recurring draw threshold is equal to 33% of the calculated positive cash flow.

In another embodiment, the recurring draw threshold can be established using a methodology that has a more aggressive profile. For example, the recurring draw threshold determination can implement the following: if the interest rate on the line of credit is greater than 5.799999%, then the recurring draw threshold is equal to 29% of the calculated positive cash flow; if the interest rate on the line of credit is greater than 5.69999% and less than 5.7999%, then the recurring draw threshold is equal to 0.7 times the monthly income deposited; if the interest rate on the line of credit is greater than 5.659% and less than 5.6999%, then the recurring draw threshold is 1 times the monthly income deposited; if the interest rate on the line of credit is greater than 5.599% and less than 5.6589%, then the recurring draw threshold is 10 times the monthly income deposited; and if the interest rate on the line of credit is less than or equal to 5.598%, then the recurring draw threshold is 12 times the monthly income deposited.

Determination of the recurring draw amount can also be determined in various ways. In one embodiment, for a line of credit interest rate less than 12.499%, the recurring draw amount is determined by multiplying a cash flow multiplier times the calculated positive cash flow amount. The cash flow multiplier that is used can be based upon the ratio or percentage of the positive cash flow divided by the net income deposited. For example, if the positive cash flow amount is $1,500 and the net income deposited is $6,000, then the ratio is 25%. The cash flow multiplier can then be determined based on a table such as that illustrated in Table 1 below.

TABLE 1

| IDENTIFIER | IDENTIFIER | Cash Flow |
|---|---|---|
| FACTOR LOW | FACTOR HI | Multiplier |
| 0.000% | 13.700% | 3 |
| 13.701% | 13.846% | 3.0157 |
| 13.847% | 14.047% | 3.0252 |
| 14.048% | 14.191% | 2.9428 |
| 14.192% | 14.390% | 2.9055 |
| 14.391% | 14.979% | 2.7638 |
| 14.980% | 15.460% | 2.6159 |
| 15.461% | 15.871% | 2.5136 |
| 15.872% | 16.419% | 2.3795 |
| 16.420% | 16.899% | 2.2714 |
| 16.900% | 17.448% | 2.1607 |
| 17.449% | 17.790% | 1.834 |
| 17.791% | 18.137% | 1.7313 |
| 18.138% | 18.475% | 1.6324 |
| 18.476% | 18.818% | 1.5954 |
| 18.819% | 19.161% | 1.5561 |
| 19.162% | 19.503% | 1.5058 |
| 19.504% | 19.850% | 1.4761 |
| 19.851% | 20.188% | 1.392 |
| 20.189% | 20.536% | 1.2497 |
| 20.537% | 20.874% | 1.2497 |
| 20.875% | 21.217% | 1.1953 |
| 21.218% | 21.560% | 1.1382 |
| 21.561% | 21.902% | 1.1203 |
| 21.903% | 22.246% | 1.0723 |
| 22.247% | 23.277% | 1.069 |
| 23.278% | 23.647% | 1.0552 |
| 23.648% | 23.990% | 1.0515 |
| 23.991% | 24.301% | 1.0435 |
| 24.302% | 24.987% | 1.0368 |
| 24.988% | 25.466% | 1.0281 |
| 25.467% | 25.672% | 1.0209 |
| 25.673% | 26.019% | 1.0143 |
| 26.020% | 26.362% | 1.0141 |
| 26.363% | 26.704% | 1.0139 |
| 26.705% | 27.047% | 1.0112 |
| 27.048% | 27.390% | 1.0101 |
| 27.391% | 27.733% | 1.0035 |
| 27.734% | 28.075% | 1.0035 |
| 28.076% | 28.418% | 1.002 |
| 28.419% | 28.761% | 1.001 |
| 28.762% | 29.103% | 1.0001 |
| 29.104% | 29.446% | 0.9996 |
| 29.447% | 29.789% | 0.9992 |
| 29.790% | 30.132% | 0.9983 |
| 30.133% | 30.474% | 0.9978 |
| 30.475% | 30.817% | 0.9974 |
| 30.818% | 31.160% | 0.997 |
| 31.161% | 99.990% | 0.9955 |

With reference to Table 1, the cash flow multiplier corresponding with 25% is 1.0281. The recurring draw amount for a positive cash flow of $600 would then be 1.0281*$600=$616.86.

In one embodiment, if the line of credit interest rate is greater than 12.499%, then the recurring draw amount is determined by multiplying the amount of the calculated positive cash flow times the cash flow multiplier of 0.961. Also, in one embodiment, if the identifier factor is greater than or equal to 21.561 percent and the loan amount is greater than or equal to 6 million dollars, then a cash flow multiplier of 1.593 is used.

In general, identification of the proper recurring draw threshold and recurring draw amount are key elements to ensure that an optimal balance is struck between the loan and the line of credit. When the interest rate on the line of credit is low, a larger recurring draw amount and recurring draw threshold can provide very favorable results. However, as interest rates on the line of credit increase, the impact of using larger recurring draw amounts can be detrimental. As would be appreciated, there is an indirect relationship between the interest rate of the line of credit and the optimal withdrawal amount.

It is therefore a feature of the present invention that a computerized tool is provided that enables an individual to identify the proper recurring draw threshold and recurring draw amount that is optimized to the individual's financial picture. The identification of the proper recurring draw threshold and recurring draw amount enables the individual to create their own tailor-made financial plan to achieve their customized financial goals.

In one embodiment, a web-based or app-based tool is provided that assists the user in identifying a tailor-made financial plan. In optimizing an average daily balance in a line of credit, the computerized tool is designed to assist the user in looking for ways to maximize their income, to deposit their income as early as possible in the billing cycle, to reduce expenses, and to delay paying expenses until as late as possible in the billing cycle. To do so, the computerized tool of the present invention is designed to present one or more graphical user interfaces that enables an acquisition of income-related and expense-related information.

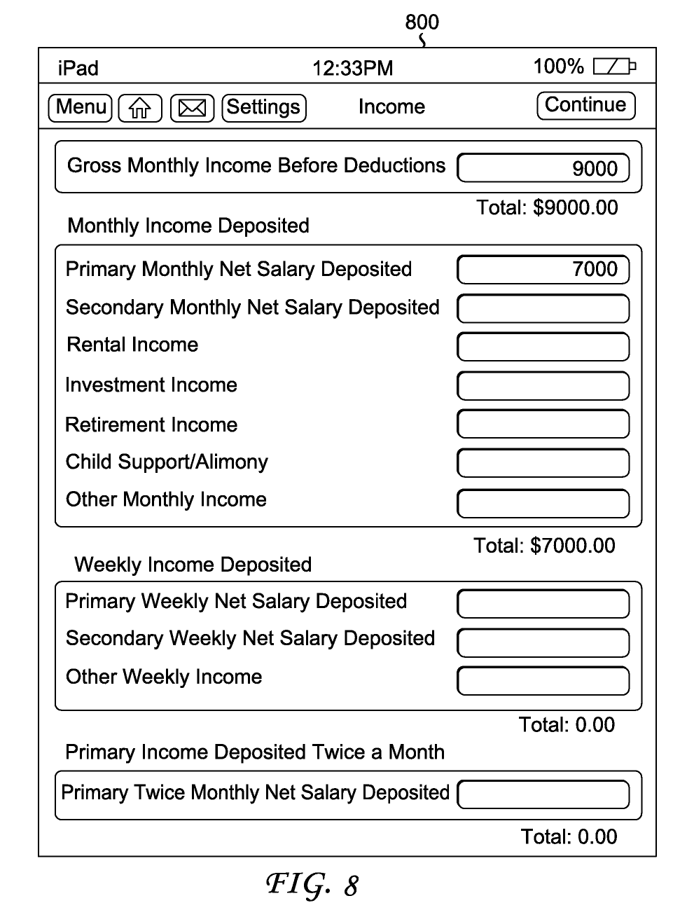

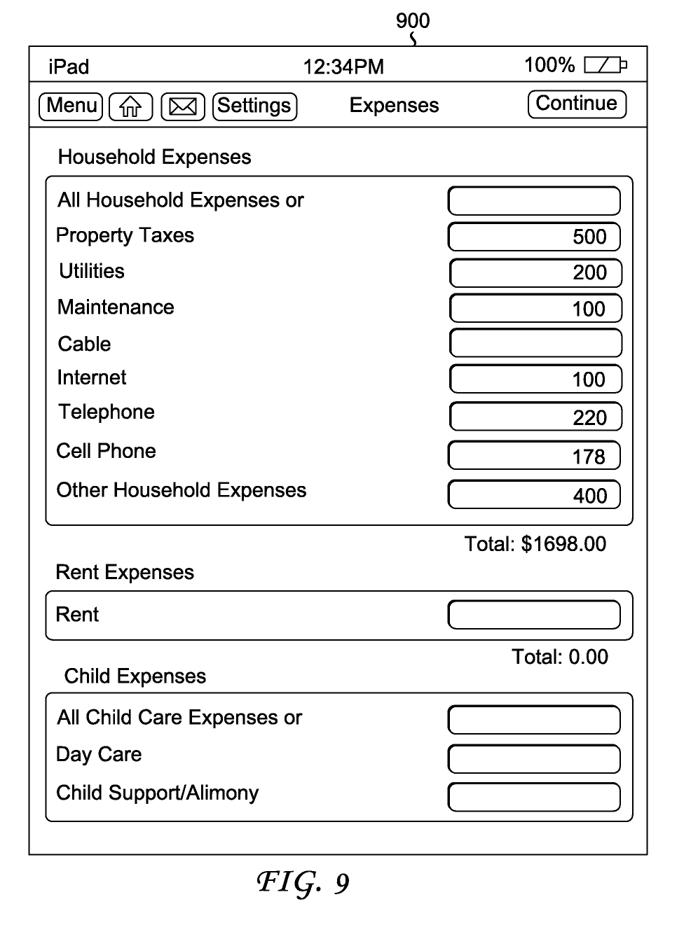

FIGS. 8 and 9 illustrate examples of graphical user interfaces 800 and 900, respectively, that enable the acquisition of income-related information and expense-related information using field-based data entry. As would be appreciated, a user interface can also be provided that enables the computerized tool to retrieve income-related information and expense-related information through the import of data from an online source or from a personal finance program (e.g., Intuit® Quicken®).

Here, it should be noted that the specific categories of income-related information and expense-related information requested from the user would be implementation dependent. In general, the extent of the information requested from the user can be designed to encourage an understanding of all income/expense components, and to formulate an accurate picture of an individual's financial profile. As such, user interfaces 800, 900 are not intended to be exhaustive. For example, income-related information can also include weekly and bi-weekly/twice-monthly forms of income that can be further specified for cash-flow purposes. Expense-related information can also include personal expenses (e.g., clothing, kids activities, club dues and fees, association fees, education expenses, charitable donations, etc.), entertainment expenses (e.g., hobbies, sports, etc.), food expenses (e.g., groceries, dining out, etc.), transportation expenses (e.g., gasoline, parking, bus fares, etc.), medical expenses (e.g., prescriptions, co-payments, etc.) insurance expenses (e.g., medical, auto, renters, etc.), or the like. Expense-related information can further include loan payments (e.g., automobile, student loans, line of credit payments, mortgages, etc.) as well as credit card payments. Additionally, income-related and expense-related information can also include savings deposits, balances, etc. that can help complete the picture of an individual's financial profile.

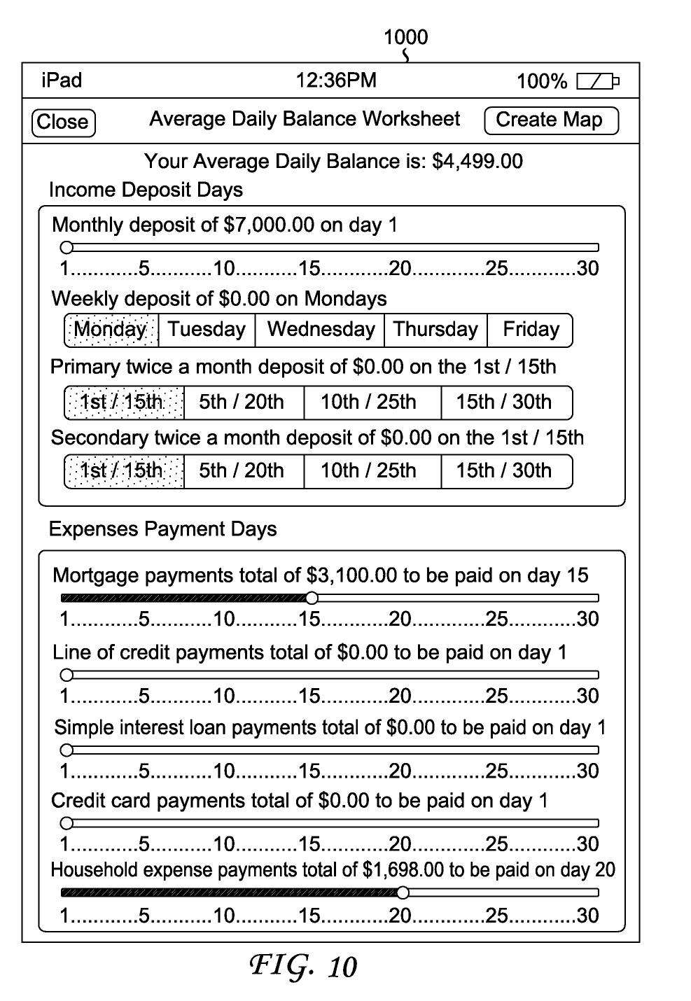

Once the income-related and expense-related information is entered, assistance is then provided in the optimization of the average daily balance. Such assistance can be enabled through the example graphical user interface 1000 illustrated in FIG. 10. As illustrated, graphical user interface 1000 enables the user to specify the dates of deposit into the line of credit for sources of income, and dates of withdrawal from the line of credit for payments of expense. A date of deposit can be specified for each income source. Similarly, a date of withdrawal can be specified for each expense item. As would be appreciated, income sources and expense items can be grouped into a single category, whose attributable date of deposit/withdrawal can be adjusted singularly.

The example user interface 1000 illustrates an interactive tool that enables the user to adjust the dates of deposits and withdrawals for the entire list of income sources and expense items. The impact of each adjustment is reflected in the average daily balance total listed at the top of the user interface. Feedback on the impact from seeming small choices is therefore provided to the user via the user interface.

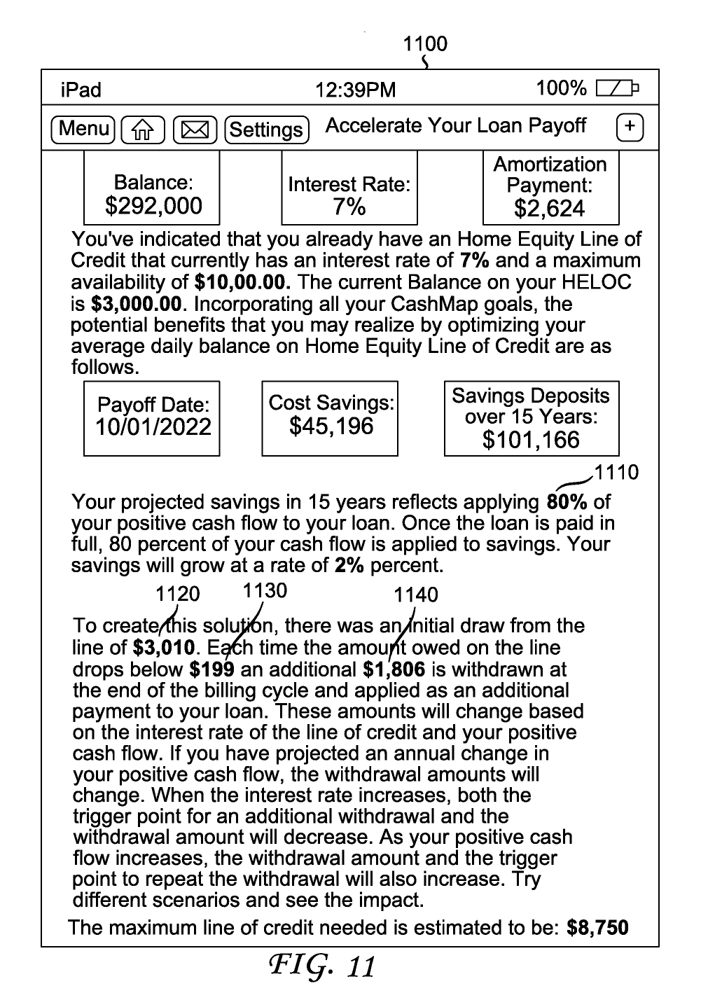

Based on the optimizations of the average daily balance specified using user interface 1000, an application of the line of credit to an accelerated payoff of a closed loan can then be provided using report screen 1100 illustrated in FIG. 11. As noted above, optimization of a line of credit can provide significant benefits in shifting small “chunks” of debt from the closed loan to the line of credit. While in theory, such a process can pay great dividends, application of an optimized average daily balance has thus far been elusive. The keys to a successful application of an optimized average daily balance to the accelerated payment on a closed loan is in identifying the optimum parameters for the accelerated payment by the user.

In the present invention, the optimum parameters are dependent on the positive cash flow. If positive cash flow does not exist, then there will be no savings from the line of credit. After all sources of income and all expense items have been specified, a total positive cash flow can be determined.

With the assumption that positive cash flow exists, the user can specify the amount (e.g., percentage) of the positive cash flow that should be applied to the line of credit. While application of 100% of the positive cash flow to the line of credit is theoretically possible, such a level of application is often impractical when considering the variances in expense that occur in a typical personal budget. In the present invention, the user can specify a portion of the determined positive cash flow (e.g., 20%-80%) that should be applied to the line of credit using a graphical user interface (not shown). This specified amount (e.g., 80%) is thereafter included in report 1100 as information 1110. For the example of a positive cash flow of $602/mo., the user-specified percentage of 80% would dictate that $602 *0.8=$481.60 would be applied to the line of credit each month. The 20% remainder that is not applied to the line of credit would go to savings.

As noted, the existence of positive cash flow indicates the existence of an optimal solution to accelerating the payment of a fixed loan using a line of credit. Example report 1100 indicates the primary parameters that a user needs to initiate the accelerated loan payoff. The first parameter is the initial draw from the line of credit. Information 1120 in report 110 identifies an amount of an initial draw to be applied as an additional payment to the mortgage. In one embodiment, the initial draw can equal to five times the current calculated positive cash flow. If the individual has last month's positive cash flow available to apply, then the initial draw can equal six times the current calculated positive cash flow. In the present example, the initial draw is calculated as 5*$602=$3,010, which is the calculated amount illustrated in information 1120 of report 1100.

The other primary parameters that a user needs to initiate the accelerated loan payoff are the recurring draw threshold and the recurring draw amount. An example mechanism for determining these parameters has been described above. For the recurring draw threshold, the use of the standard profile defined above would begin with an analysis of the interest rate of the line of credit. Here, the 7% interest rate of the line of credit would dictate that the recurring draw threshold would be equal to 33% of the positive cash flow (i.e., 0.33*$602=$199). This recurring draw threshold is reported as information 1130 in report 1100.

Finally, the recurring draw amount would be determined using the cash flow multiplier described above with reference to Table 1. In this case, the cash flow multiplier is determined using the ratio of the positive cash flow divided by the net income deposited, which is $602/$7,000=8.6%. Based on the example of Table 1, the 8.6% ratio would translate to a cash flow multiplier of 3. The resulting recurring draw amount is then determined by multiplying the cash flow multiplier by the positive cash flow, which is 3*$602=$1,806.

Report 1100 provides a key mechanism in enabling the individual to execute a plan born out of an optimized average daily balance. Specifically, the individual can take an initial draw of $3,010 to be applied as an additional payment on the mortgage. After executing the plan for optimizing the average daily balance, the individual can then determine when the balance on the line of credit crosses $198. At that time an additional recurring draw amount of $1,806 would be applied as an additional payment on the mortgage.

As further illustrated in FIG. 11, report 110 can include a total cost savings (i.e., $45,196) produced by utilizing recurring draw payment plan based on the parameters in information 1110, 1120, 1130 and 1140. This cost savings would be relative to a conventional payment plan based on the $2,624 amortization payment. Further, report 110 can include a calculation of the savings deposits generated over the 15-year life of the mortgage. This calculation is based on the application of 80% of the positive cash flow, after completed payment of the mortgage, to savings. At a growth rate of 2%, the savings deposit over 15 years would be $101,166. The display of the savings deposit over 15 years provides the individual with critical feedback in understanding the true value of leveraging an optimized average daily balance on a line of credit over an extended period of time. This is clear evidence to the user of small changes producing a large result.

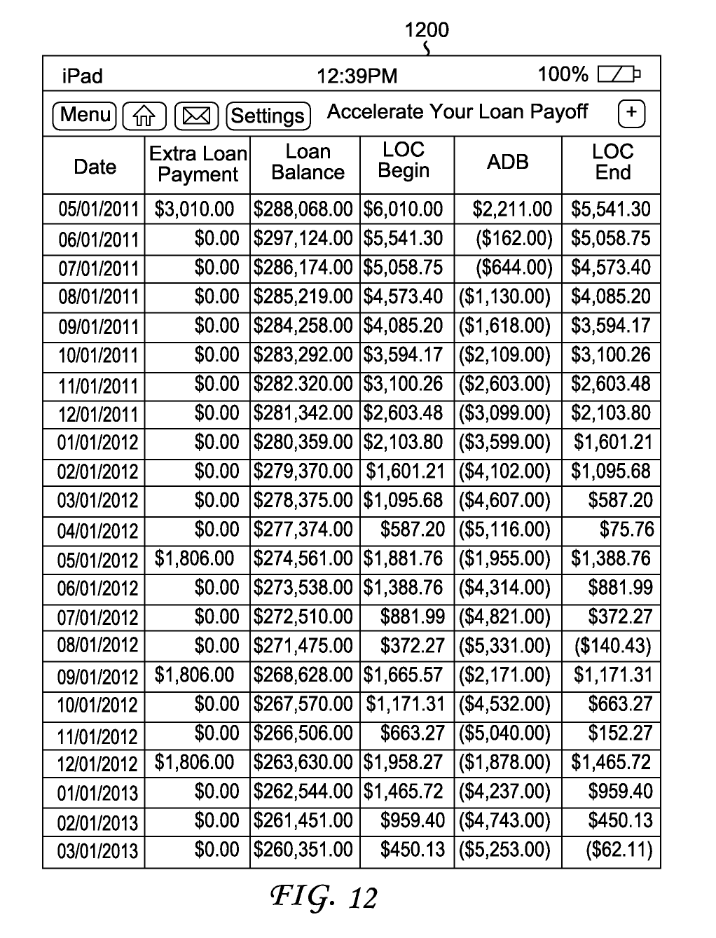

As has been described, the tool of the present invention enables an individual to identify the optimal average daily balance on a line of credit based upon the amount of personal financial information provided. Multiple scenarios can be retained and then used to create financial projections regarding the total interest that will be paid, the savings that can be realized and future cash savings. An example of a report of an impact of executing of an accelerated loan payoff plan using optimization of an average daily balance is illustrated in FIG. 12. As illustrated, report 1200 identifies the projected points in time at which the line of credit balance would cross the recurring draw threshold (e.g., May 2012, September 2012, etc.), thereby producing additional recurring draw amounts of $1,806 as additional loan payments.

In general, the financial tool of the present invention is designed to determine, based on a line of credit interest rate, loan details, cash flow, and an individual's customized average daily balance optimization, a plan to maximize savings and accelerate the payoff of the loan. In general, if the line of credit interest rate is higher, then the recurring draw amount from the line of credit is reduced to minimize the average daily balance on the line of credit.

It is a feature of the present invention that optimizing the average daily balance can be based on traditional banking products. For example, an automatic bill payment service can be used to ensure reoccurring expenses are made by the last date of a given vendor's grace period, and a credit card with a due date established at the end of the month can used with a limited line that matches the routine purchases an individual makes each month. In one embodiment, an interface can also be provided that enables an individual to automatically have funds shifted from their line of credit to their checking account as an electronic transfer to the loan of their choice.

While the method of execution of an accelerated payoff plan using a line of credit having an optimized average daily balance can be based on conventional means, it is significant that the financial tool provided by the present invention enables identification of such an accelerated payoff plan. Notably, the financial tool of the present invention enables identification of a recurring draw amount and a recurring draw threshold that is optimized to an individual's current situation. Without such a tool, an accelerated payoff plan's impact would be muted.

It should be noted that the principles of the present invention can also be applied to a scenario where an individual has only a line of credit. In this scenario, the financial tool's income and expense settings can be used to assist the individual in optimizing the average daily balance on the line of credit, thereby facilitating efficient repayment of the balance of the line of credit. While a recurring draw amount and recurring draw threshold would not be needed, the individual can still specify a percentage of positive cash flow that is withdrawn from the line of credit for deposit into savings. The cumulative impact of such a plan that is defined using the financial tool can then be provided in a report that includes information such as the payoff date, cost savings, and savings deposits over the relevant period.

In one embodiment, the financial tool of the present invention can be embodied in a computing apparatus having computer readable program code loaded thereon, which enables configuration of the computing apparatus to generate graphical user interface screens that enable data capture. The computer readable program code loaded on the computing apparatus is also designed to generate graphical user interface screens that enable the display of results generated by the configured processing of captured data by a processing element in the computing apparatus. The transformation of user-provided data into a result communicated to the user enables the user to leverage the financial tool to create a financial plan for immediate execution.

In one embodiment, the financial tool of the present invention can be embodied in a web browser interface where graphical user interface screens are generated within one or more windows within the web browser. In another embodiment, the financial tool of the present invention can be embodied in a mobile computing device that is configured using an application loaded thereon. For example, the principles of the present invention can be carried out by a device such as an iPad by Apple, which as been configured using an app downloaded from an App Store. In yet another embodiment, the financial tool of the present invention can be embodied in a general purpose computer that is designed to display graphical user interfaces generated via a custom application.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the description should not be considered to be exclusive of these other embodiments. Also, it is to be understood that the phraseology and terminology employed herein are for the purposes of description and should not be regarded as limiting.

What is claimed is:

1. A method for managing a draw of funds from a line of credit for recurring additional payments on a loan, comprising the following computer implemented steps:
receiving, via a first graphical user interface, first user inputs that identify one or more monthly income sources, each of said one or more monthly income sources being assigned a day of a month, wherein an assigned day for an associated monthly income source corresponds to a day that income from said associated monthly income source is applied to a line of credit;
receiving, via a second graphical user interface, second user inputs that identify one or more monthly expenses, each of said one or more monthly expenses being assigned a day of a month, wherein an assigned day for an associated monthly expense corresponds to a day that funds are drawn from said line of credit to pay for said associated monthly expense;
determining a recurring draw threshold for said line of credit based on an interest rate for said line of credit;
determining a recurring draw amount for said line of credit based on a positive cash flow, said positive cash flow representing an amount of a total of said one or more monthly income sources that exceeds a total of said one or more monthly expenses; and
displaying, on a display of an electronic device, said recurring draw threshold for said line of credit and said recurring draw amount, said recurring draw amount representing an amount that a user draws from said line of credit when a balance of said line of credit crosses said recurring draw threshold.

2. The method of claim 1, further comprising displaying a third graphical user interface that enables a user to specify a day of a month that income from a monthly income source is applied to said line of credit.

3. The method of claim 1, further comprising displaying a third graphical user interface that enables a user to specify a day of a month that funds are drawn from said line of credit to pay for a monthly expense.

4. The method of claim 1, wherein said determining a recurring draw threshold comprises comparing said interest rate of said line credit to one or more interest rate threshold values, and determining said recurring draw threshold based on a result of said comparison.

5. The method of claim 1, wherein said determining a recurring draw amount comprises:
determining a cash flow multiplier based on a ratio of a monthly loan payment amount divided by a total of amounts of said one or more monthly income sources; and
multiplying said cash flow multiplier by said positive cash flow.

6. The method of claim 1, further comprising displaying a monthly amortization schedule that includes a balance of said line of credit and said recurring draw amounts as additional recurring payments on said loan.

7. The method of claim 6, further comprising displaying a second monthly amortization schedule that includes additional monthly payments on said loan, said additional monthly payments being determined as a percentage of said positive cash flow.

8. A method for managing a draw of funds from a line of credit for recurring additional payments on a loan, comprising the following computer implemented steps:
receiving, via a first graphical user interface, first user inputs that identify one or more monthly income sources;
receiving, via a second graphical user interface, second user inputs that identify one or more monthly expenses;
displaying a third graphical user interface on a display of an electronic device, said third graphical user interface enabling a user to change a day in which income from one of said one or more monthly income sources is applied to a line of credit and to change a day in which funds are drawn from said line of credit to pay for one of said one or more monthly expenses, wherein said third graphical user interface includes an average daily balance for said line of credit that is responsive to said changes;
displaying, on a display of an electronic device, a recurring draw threshold for said line of credit that is based on an interest rate for said line of credit, and a recurring draw amount for said line of credit that is based on a positive cash flow, said positive cash flow representing an amount of a total of said one or more monthly income sources that exceeds a total of said one or more monthly expenses, wherein said recurring draw amount represents an amount that a user draws from said line of credit when a balance of said line of credit crosses said recurring draw threshold; and
displaying, on said display of said electronic device, a monthly amortization schedule that includes said recurring draw amounts as additional recurring payments on said loan, a balance of said line of credit at a start of a month, and an average daily balance of said line of credit during a month.

9. The method of claim 8, further comprising determining a recurring draw threshold using a comparison of an interest rate of said line credit to one or more interest rate threshold values.

10. The method of claim 8, further comprising determining a recurring draw amount by determining a cash flow multiplier based on a ratio of a monthly loan payment amount divided by a total of amounts of said one or more monthly income sources, and multiplying said cash flow multiplier by said positive cash flow.

11. The method of claim 1, further comprising displaying a second monthly amortization schedule that includes additional monthly payments on said loan, said additional monthly payments being determined as a percentage of said positive cash flow.

12. A method for enabling management of a draw of funds from a line of credit for recurring additional payments on a loan, comprising the following computer implemented steps:
receiving a request via an electronic network; and
transmitting, in one or more segments in response to said request, computer readable program code that enables an electronic device to perform the following steps:
receiving, via a first graphical user interface, first user inputs that identify one or more monthly income sources, each of said one or more monthly income sources being assigned a day of a month, wherein an assigned day for an associated monthly income source corresponds to a day that income from said associated monthly income source is applied to a line of credit;
receiving, via a second graphical user interface, second user inputs that identify one or more monthly expenses, each of said one or more monthly expenses being assigned a day of a month, wherein an assigned day for an associated monthly expense corresponds to a day that funds are drawn from said line of credit to pay for said associated monthly expense;
determining a recurring draw threshold for said line of credit based on an interest rate for said line of credit;
determining a recurring draw amount for said line of credit based on a positive cash flow, said positive cash flow representing an amount of a total of said one or more monthly income sources that exceeds a total of said one or more monthly expenses; and
displaying, on a display of an electronic device, said recurring draw threshold for said line of credit and said recurring draw amount, said recurring draw amount representing an amount that a user draws from said line of credit when a balance of said line of credit crosses said recurring draw threshold.

13. The method of claim 12, wherein said computer readable program code further enables said electronic device to display a third graphical user interface that enables a user to specify a day of a month that income from a monthly income source is applied to said line of credit.

14. The method of claim 12, wherein said computer readable program code further enables said electronic device to display a third graphical user interface that enables a user to specify a day of a month that funds are drawn from said line of credit to pay for a monthly expense.

15. The method of claim 12, wherein said determining a recurring draw threshold comprises comparing said interest rate of said line credit to one or more interest rate threshold values, and determining said recurring draw threshold based on a result of said comparison.

16. The method of claim 12, wherein said determining a recurring draw amount comprises:
determining a cash flow multiplier based on a ratio of a monthly loan payment amount divided by a total of amounts of said one or more monthly income sources; and
multiplying said cash flow multiplier by said positive cash flow.

17. The method of claim 12, wherein said computer readable program code further enables said electronic device to display a monthly amortization schedule that includes a balance of said line of credit and said recurring draw amounts as additional recurring payments on said loan.

18. The method of claim 17, wherein said computer readable program code further enables said electronic device to display a second monthly amortization schedule that includes additional monthly payments on said loan, said additional monthly payments being determined as a percentage of said positive cash flow.
